(19) United States
(12) Patent Application Publication
(10) Pub. No.: US 2013/0099558 A1
(43) Pub. Date: Apr. 25, 2013

(54) WELDING MODULE INCLUDING DUAL CYCLE POWER SYSTEM

(71) Applicant: David V. Hart, Vancouver (CA)

(72) Inventor: David V. Hart, Vancouver (CA)

(73) Assignee: VANGUARD EQUIPMENT, INC., Tlusa, OK (US)

(21) Appl. No.: 13/448,370

(22) Filed: Apr. 16, 2012

Related U.S. Application Data
(60) Provisional application No. 61/476,132, filed on Apr. 15, 2011.

(51) Int. Cl. F16L 1/00; H02J 3/00

(52) U.S. Cl. CPC F16L 1/00; H02J 3/00
USPC 307/9.1; 29/825; 307/31

(57) ABSTRACT

A device has an engine mechanically coupled to a generator, and a plurality of electrical receptacles coupled to the generator. The device also includes a transformer and a selector switch for selectively placing the transformer in a circuit containing at least one of the plurality of electrical outlets.

### CROSS REFERENCE TO RELATED APPLICATIONS

This application claims the priority of U.S. Provisional Patent Application No. 61/476,132 entitled “WELDING MODULE INCLUDING DUAL CYCLE POWER SYSTEM,” filed Apr. 15, 2011, the contents of which are hereby incorporated by reference.

### FIELD OF THE INVENTION

The present invention relates, generally, to pipeline welding operations. The present invention relates more specifically to power systems for pipeline welding operations.

### BACKGROUND OF THE INVENTION

Pipeline construction requires specialized equipment. Before construction of a pipeline begins, the topography is surveyed along the pipeline right of way. The right of way is then cleared of vegetation. Topsoil is removed from the work area and stockpiled. Backhoes or trenching machines may be used to excavate a pipeline trench. The soil that is excavated during ditching operations is typically temporarily stockpiled on the non-working side of the trench.

Individual joints of pipe are distributed, or strung, along the right of way according to a design plan. Pipe may be located adjacent to an excavated ditch and arranged so the pipe segments are accessible to construction personnel. A mechanical pipe-bending machine may be necessary to bend individual joints of pipe to a desired angle at locations where significant changes are required to fit the topography of the right of way, e.g. to follow natural ground contours or pipeline route direction changes.

In marine environments, a welding system may be affixed to a welding platform (or a barge). The pipe may be welded underwater or above water and lowered into the water by a boom/hoist system.

After the pipe is strung and bent, the pipe sections are aligned. Pipe ends may be beveled. The pipe segments are clamped into place. The pipe segments are then welded together, and placed on temporary supports along the edge of the trench. All welds are then visually and radio graphically inspected. Line pipe is typically coated prior to stringing. However, the welded segments require a coating at the welded joints.

Welding of sections of pipe, once clamped is commonly accomplished through the use of manual or automatic welding operations. Welding machines require a power supply for operation. Power on a pipeline welding operation is often provided by portable power generation modules. These may include gas or diesel engines used in association with a generator or alternator to provide electrical power to the welding machines.

In addition to welding machines, other tools and/or implements require electrical power on the pipeline which is also often provided by the generator/alternator. For example, in a welding operation, the weld, once applied, is often ground smooth and tested. The grinding and testing equipment requires electrical power supplied by the generator/alternator.

When automatic welding machines are employed it is common for a portable structure to be lifted over the sections of pipe to be welded and then moved to the next section once the first section weld is completed. Such portable structures often include portable air conditioning and/or heating systems for the comfort of the welding personnel. Such air conditioning and heating systems often are powered from electricity provided by the generator/alternator. In addition, electrical lighting or other electrical tools/implements may require power from the generator/alternator. It is also common to provide compressed air for operation of pneumatic tools. Such air compressors are often powered by the generator/alternator.

Due to the temporary nature of pipeline projects, it is common for pipeline construction equipment to be rented and shipped to the construction location anywhere in the world. One known problem is the fact that electrical power requirements are not uniform throughout the world. For example, certain countries employ 60 Hz power and others 50 Hz. As a result, companies that rent power systems must make them available for both 50 Hz and 60 Hz operation so that the auxiliary tools can be properly in the geographic location of the pipeline construction. A need, therefore exists for a single power system which can be alternated between 50 Hz and 60 Hz operation.

In addition, different countries employ different power outlets for electrical supply. For example, a power tool designed for Europe may not fit receptacle designed for Asia. This is such independent of the frequency requirements. A need, therefore also exists for a power supply module which can be easily modified to provide the proper power receptacles for the geographic location in conjunction with the required frequency requirement.

Once all welds are completed and inspected, the pipe assembly is then lowered into the trench, typically with side-boom tractors. The trench is then backfilled using a backfilling or bladed equipment.

Pipelines may be hundreds or thousands of miles in length. Therefore, it is important to maximize the speed at which the above steps may be completed.

Additionally, pipeline construction is undertaken in various countries around the world. It is, therefore, desirable to provide equipment, such as a power generator, useful to power welding equipment and related power tools/implements that is easily adapted to be compatible with local equipment standards.

### SUMMARY OF THE INVENTION

In pipeline construction, it is desirable to provide power generation that is independent of the carrier to allow a welding unit to be moved without shutting down power to the welding unit. Therefore, faster cycle time for welding joints of pipe can be achieved. The welding unit of the present disclosure provides improved cycling time of line-up clamps since the air compressor can be operated without downtime while moving the unit, thereby replenishing air much faster than with other designs.

The present invention is a welding module that provides an interchangeable or dual cycle power system. The module includes, generally, a platform that is capable of removable attachment to a vehicle, most commonly a land vehicle such as a bulldozer, pipelayer, or other such vehicle used for welding operations, such as pipeline/pipelaying. The welding unit preferably includes interchangeable adapter plates to allow for mounting onto a variety of carriers. For the purpose of example only, and without limitation, the welding unit could be used with D5M/N, D6M/N, D6D/E, 571G/F, 572G/R or Challenger units, via a winch mount, or the welding unit can be supplied in a self-contained, skid-mount arrangement.

The welding module may include a generator, a gas or diesel fueled engine that is preferably directly coupled to the generator/alternator to improve fuel efficiency, an air compressor module, an air tank module, a welder module, and a control distribution module. The control distribution module includes controls for the engine, generator/alternator compressor, and welders. In addition, the control distribution module includes electrical and control circuitry for the welding module. The control distribution module in the preferred arrangement is dual cycle in that it may be interchangeable between frequency requirements. In the preferred arrangement, the control distribution module may be interchangeable between 50 Hz and 60 Hz as required for use in a particular geographic location. In a preferred embodiment, the welding module can be installed and removed quickly. The module is bolted to the carrier. A field line is connected to the carrier's fuel tank. A front platform module, if required, is pinned to the carrier using existing tractor pins for easy installation and removal. Both modules can be easily removed when not in use to free the machine for other work.

In an alternate preferred, marine welding environment, the module may be bolted to a welding platform or barge. Welding can be accomplished underwater or on the platform/barge.

In a preferred embodiment, the power control or control distribution module includes a dual system for 50 Hz and 60 Hz operation and may be easily switched between either as required for a particular application. In combination therewith, the power receptacle panel is interchangeable to accommodate the required duty cycle and power receptacles as required. For example, a power receptacle is provided that is standard in the geographic location in which the welding module is being operated. Interchangeability is accomplished by a quick disconnect system that includes unique connectors that are mated to the appropriate duty cycle so that the receptacles cannot be inadvertently connected to the wrong cycle wiring in error.

The control distribution module is preferably provided with a first compartment and a second compartment, wherein said first compartment contains controls and gauges for the engine and generator/alternator. This may include, by way of example, an engine oil pressure gauge, water temperature gauge, AC meter phase selector switch, 3-phase AC supply power gauges (Hz, volts, Amps) DC volt gauge and an hour meter gauge, an engine start/stop control, control panel lights, cold weather ether assist and an idle/run throttle control, a plain 3-phase power breaker, and an Engine Control Module capable of controlling engine coolant and oil function/operation. In a basic embodiment the ECM could be replaced with an engine low coolant shut down switch, a high water temperature shut down switch, a low oil shut down switch and an over-speed safety shut down switch. The control panel also preferably includes an engine fault audible alarm, and an emergency shut down button, an air compressor start/stop control and an air pressure gauge.

The second compartment contains in a preferred arrangement, a 200 AMP main breaker and sub power circuits, a supply frequency protection, 50 Hz and 60 Hz circuit breakers, ground connection, genset control strip, distribution buss, AC meter sensors, fuses, main power supply gauges, and five 230 volt/50 Hz and five 480 volt welding receptacles and optionally five 230 volt/50 Hz and five 120 volt and two 230 volt 60 Hz receptacles as well as a dial frequency selector switch.

By separating the controls into a first compartment and a second compartment, as described above, access can be controlled to allow workers who need to view the gauges and to operate the controls in the first compartment to do so, while restricting all but approved personnel from accessing or changing the cycle system from a first setting to a second setting, e.g., from 50 Hz to 60 Hz.

Thus, the present invention is well adapted to carry out the objects and attain the ends and advantages mentioned above as well as those inherent therein. While presently preferred embodiments have been described for purposes of this disclosure, numerous changes and modifications will be apparent to those skilled in the art. Such changes and modifications are encompassed within the spirit of this invention as defined by the appended claims.

The invention of the present disclosure, in one aspect thereof, comprises a device having an engine mechanically coupled to a generator, and a plurality of electrical receptacles coupled to the generator. The device includes a compressor, and an arc welder receptacle connected to the generator. The device also includes a transformer and a selector switch for selectively placing the transformer in a circuit containing at least one of the plurality of electrical outlets.

In some embodiments, the selector switch further controls the engine and generator to change an alternating current frequency of output power from the generator. In some embodiments, the generator is a three phase alternating current generator. The arc welder receptacle may be connected to all three power phases of the generator. The at least one of the plurality of electrical receptacles may be connected to less than three of the power phases of the generator.

A vehicle mountable or marine welding platform may retain the engine and generator.

The invention of the present disclosure, in another aspect thereof, comprises a mobile power device. The device includes a vehicle mountable platform, an engine mounted to the platform, and an alternating current generator mechanically powered by the engine. A plurality of electrical receptacles are coupled to the generator. A transformer is selectively integrable to a circuit containing at least one of the plurality of receptacles such that the transformer alters the voltage between the generator and the at least one of the plurality of receptacles. A switch selectively integrates the transformer into the circuit and changes the speed of the engine to change the speed of the generator such that a voltage and cycle of the at least one receptacle is altered.

In some embodiments, the generator is a three phase generator. An arc welder may be mounted to the platform and connected to the generator. A compressor may also be mounted to the platform and connected to the generator. The at least one electrical receptacle may be connected to less than three phases of the generator.

The invention of the present disclosure, in another aspect thereof, comprises a method of providing power. The method includes providing a mobile platform, attaching an engine to the mobile platform, and mechanically connecting an alternating current generator to the engine. A plurality of electrical receptacles are provided and coupled to the generator. The method includes selectively incorporating a transformer into a circuit containing at least one of the electrical receptacles to alter a voltage from the generator to the at least one receptacle, and selectively adjusting an operating speed of the engine to alter a cycle of the generator.

The method may include connecting a switch to control the selective incorporation and the selective adjustment. An arc welder may be provided on the mobile platform and connected it to the generator. A compressor may also be provided on the mobile platform and selectively connected it to the generator. In some embodiments, the generator is a three phase generator and the at least one of the electrical receptacles is connected to less than three phases of the generator.

### BRIEF DESCRIPTION OF THE DRAWINGS

FIG. 1 is a perspective view of the welding module of the invention;

FIG. 2 is a plan view of the welding module of FIG. 1, shown affixed to the rear of a vehicle;

FIG. 3 is a plan view of the welding module of FIG. 1, depicted with the welding module open revealing multiple welding units.

FIG. 4 is a plan view of the welding module of FIG. 1, taken along lines 4-4 of FIG. 3;

FIG. 5 is a plan view of the control distribution module of the welding module of FIG. 1, shown with the first door and second door closed and locked;

FIG. 6 is a plan view of the control distribution module of FIG. 5, shown with the first door in phantom lines revealing the engine control panel and the second door closed and locked;

FIG. 7 is a plan view of the control distribution module of FIG. 5, shown with the first and second doors removed to an reveal internal layout;

FIG. 8 is a detailed view of the frequency switch assembly B of FIG. 7;

FIG. 9 is a front view of the receptacle panel of FIGS. 1-4 and 4-8.

FIG. 10 is a rear view of the receptacle panel of FIGS. 1-3 and 4-7;

FIG. 11A is a schematic diagram of a first portion of a circuit diagram illustrating one possible arrangement of receptacle and compressor wiring.

FIG. 11B is a schematic diagram of a second portion of a circuit diagram illustrating one possible arrangement of receptacle and compressor wiring.

FIG. 12 is a schematic diagram of a control panel suitable for use with the systems of the present disclosure.

### DETAILED DESCRIPTION OF THE PREFERRED EMBODIMENTS

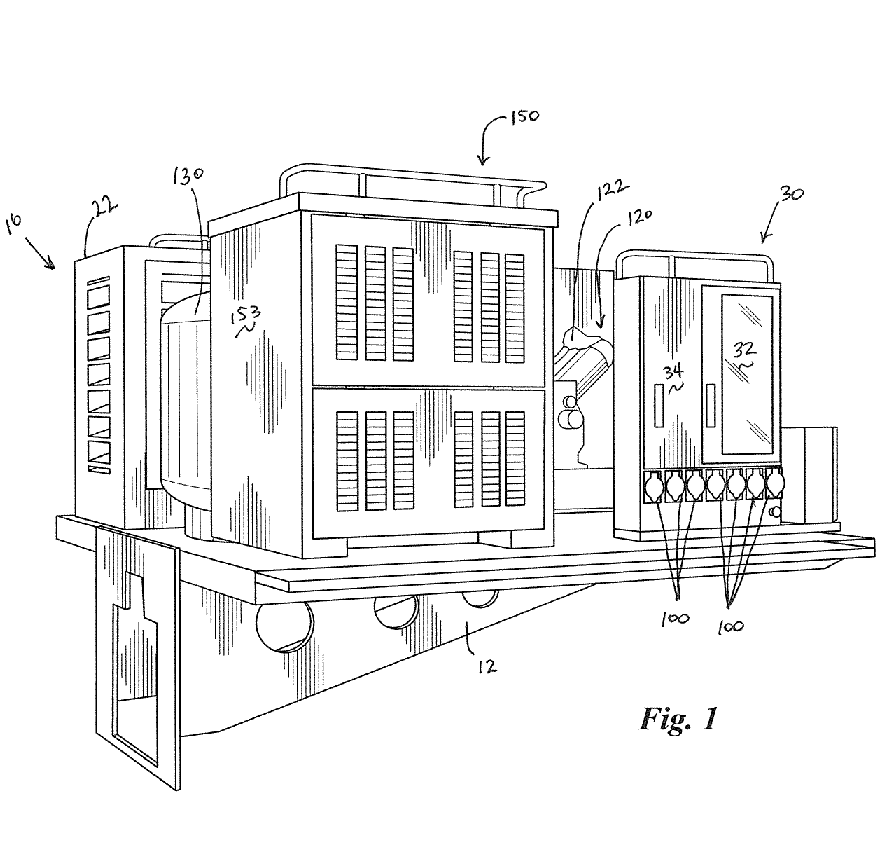

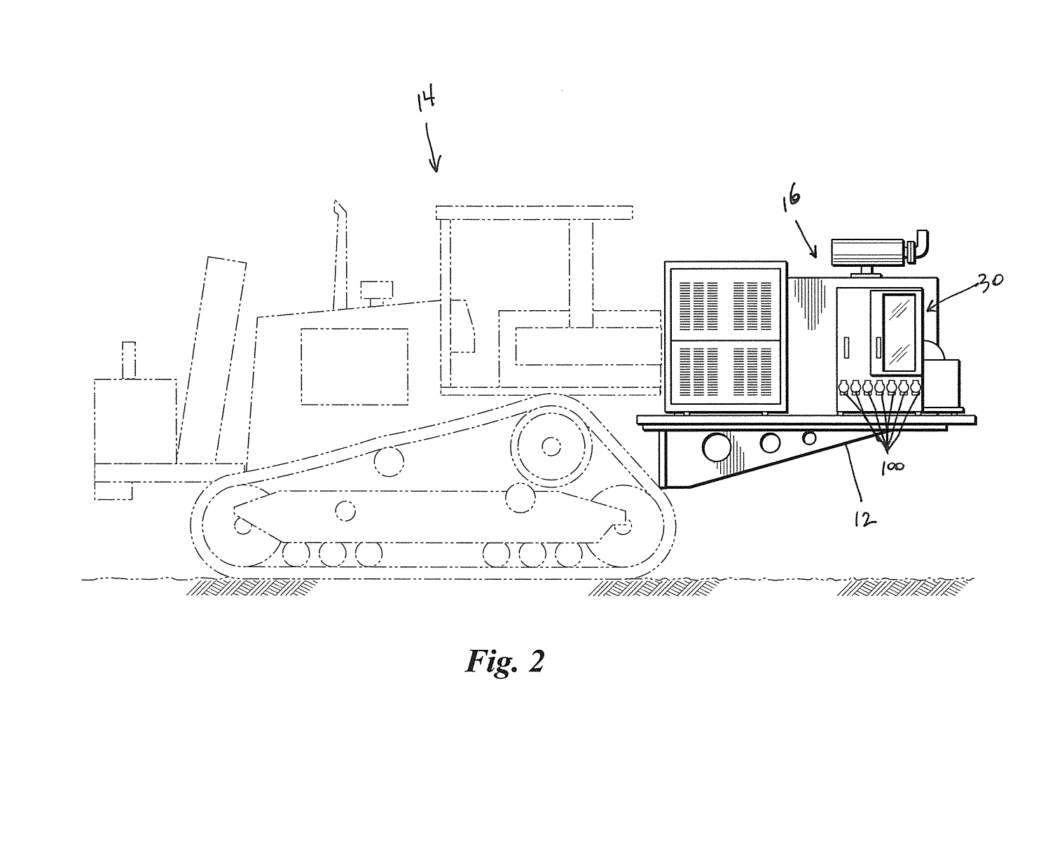

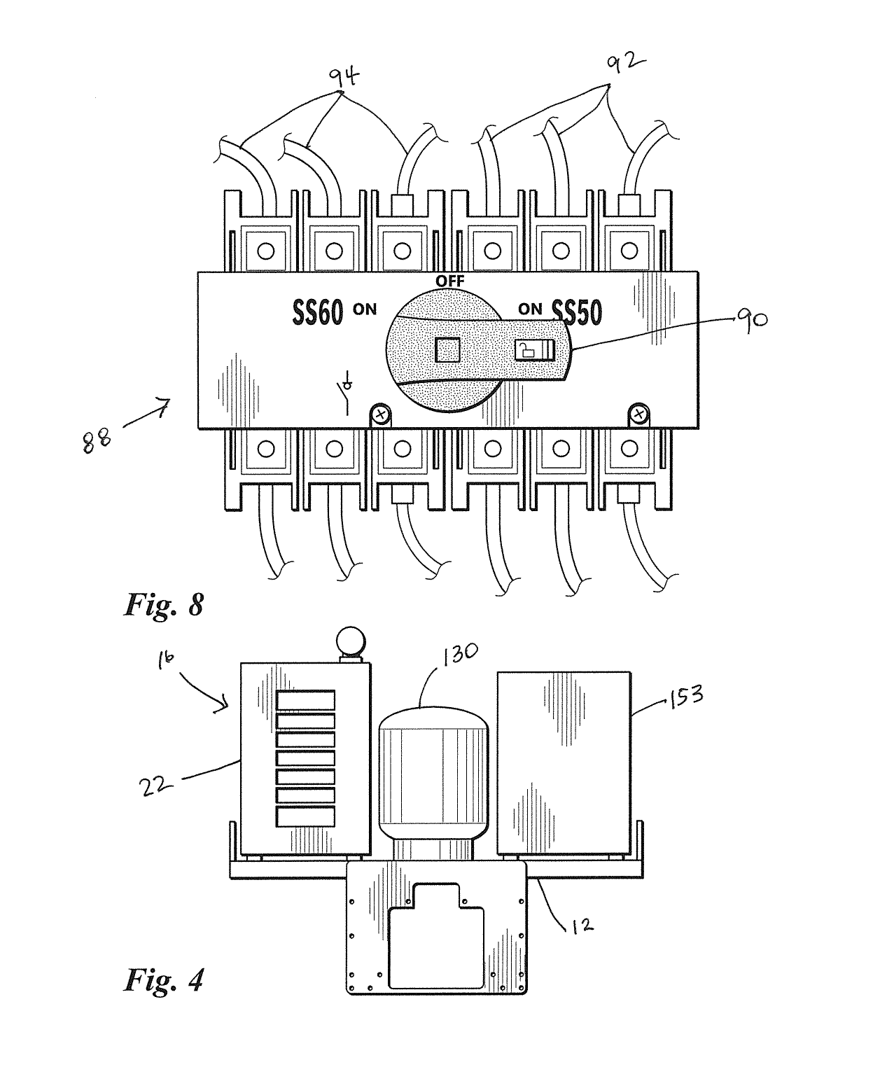

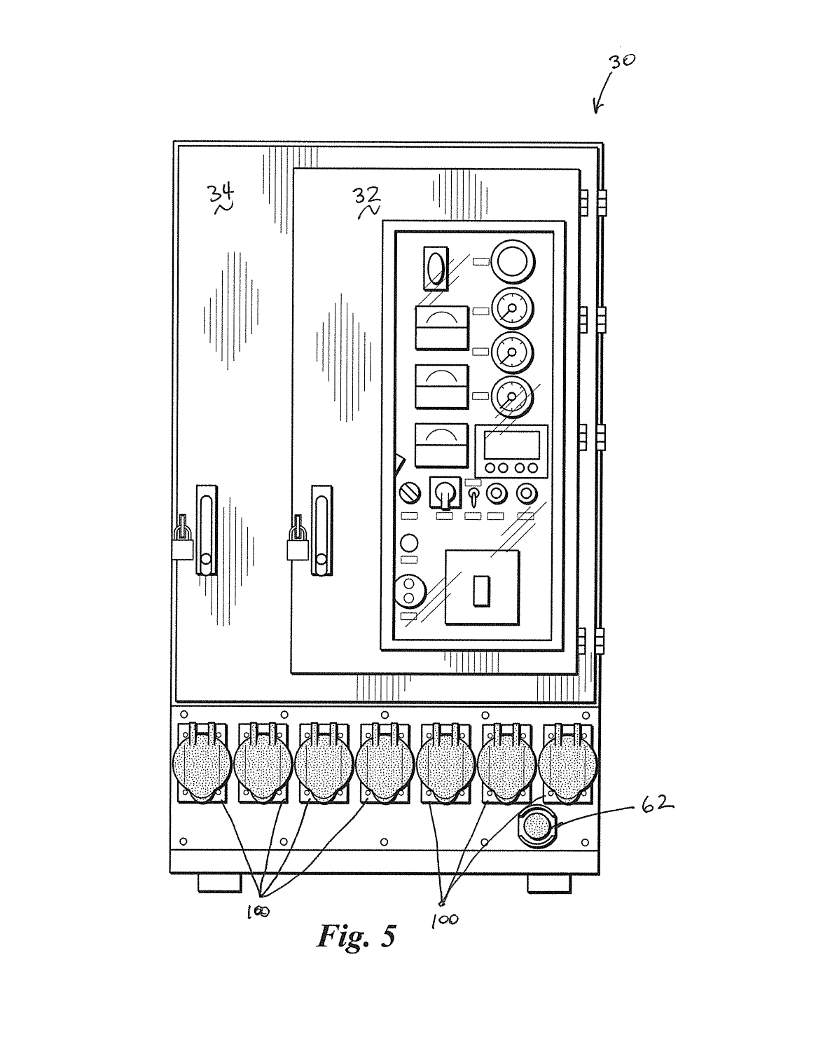

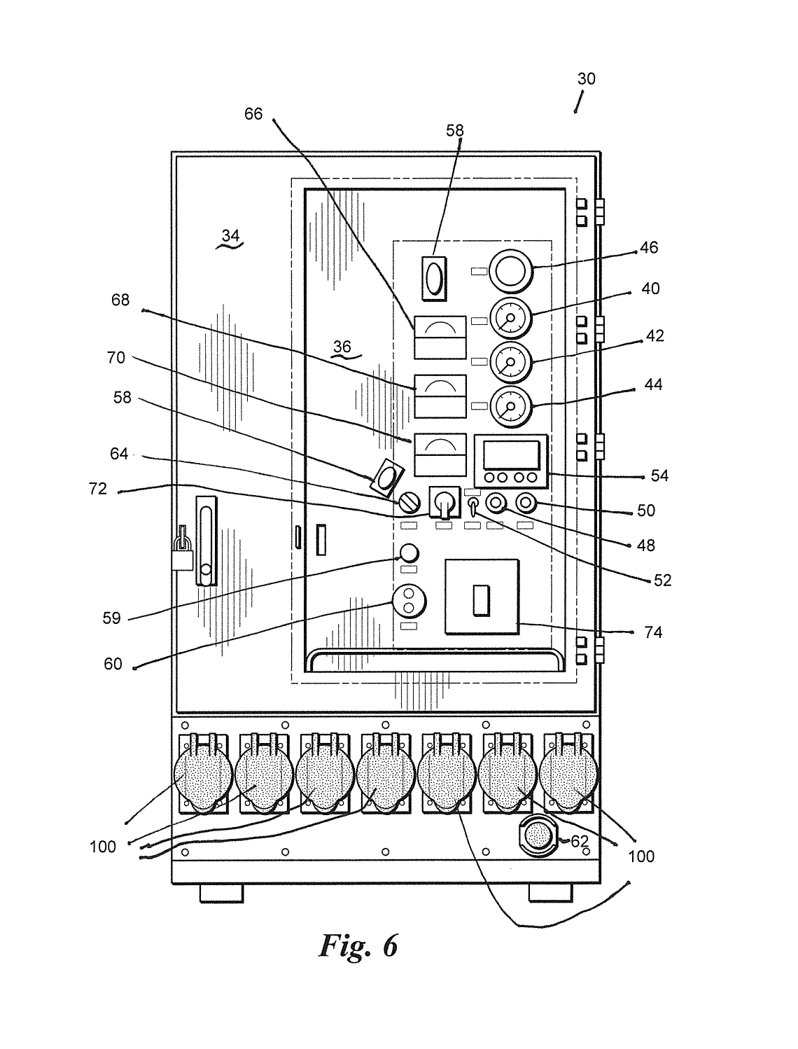

As shown in FIG. 1, the welding module/dual cycle power system is designated generally 10. System 10 includes a platform module 12 provided for removable attachment to a vehicle 14. The platform module 12 has a universal bolting pattern for mounting onto vehicle 14, as shown in FIGS. 2-4. Examples of vehicle 14 include a bulldozer or other machines known in the art for pipeline construction. Platform module 12 optionally includes a lockable toolbox, racks for accommodating gas bottles and cranes as well as other known equipment. In one embodiment, the platform module has a transport width of 107.75″, a working width of 125.5″, and a length of 103.9″, which may be extendable with catwalks to for an additional 14.1″.

Generator module 16 is affixed to platform module 12. Generator module 16 includes an engine (surrounded by enclosure 22) and generator 20. An example engine 20 is a 170 horsepower 6 cylinder internal combustion engine. A suitable example engine is a Cummins ZS B7-G1 NR3 generator drive engine, however other engines may be suitable provided they are both generator drive (g drive) and dual frequency. An example generator 20 is a 156 kVA generator. Generator 20 is preferably mounted on isolator mounts and housed in lockable enclosure 22. Generator 20 is capable of producing a variety of voltages at desired cycles. For example, generator 20 may be capable of producing 120/240/480 volts at 60 Hz or 240/415 volts at 50 Hz. A suitable generator is a Marathon Electric Alternator, model number 363PSL1607. However, it is understood that other generators/alternators capable of producing at least 156 KVA@60 Hz and 125 KVA@50 Hz could be employed. For example marine application engine/generator/alternator combinations could be substituted for use on marine welding platforms.

Control distribution module 30 is located on platform module 12. Control distribution module 30 includes control box 31. Control box 31 is preferably provided with a first door 32 and second door 34. First door 32 provides access to first compartment 36. Second door 34 provides access to second compartment 38.

First compartment 36 contains engine and compressor controls (control panel) and system monitoring gauges, including engine oil pressure gauge 40, water temperature battery charge 42, DC volt gauge 44, and an hour meter gauge 46, an engine start/stop control 48, cold weather assist 50 and an idle/run throttle control 52. Control panel/first compartment 36 also may include an Engine Control Module (ECM) 54 with a display 56. ECM 54 monitors and controls the engine functions including coolant, engine oil, engine speed, etc. Included within ECM 54 are an engine low coolant shut down switch, a high coolant temperature shut down switch, a low oil shut down switch, an over-speed safety shut down switch, and other such contact functions known in the art. First compartment 36 may also include emergency engine shutdown button 62, air compressor start/stop control 64 and air pressure gauge control panel lights 5, collectively 58, control panel illumination button 59, and an engine fault audible alarm 60. Control panel/first compartment 36 preferably includes control meters for 3-phase AC supply power including Hz 66, volts 68 and amps 70 and preferably also includes AC meter phase selector switch 72. A main 3-phase supply breaker with shunt trip (over/under frequency) is also preferably included in first compartment 36.

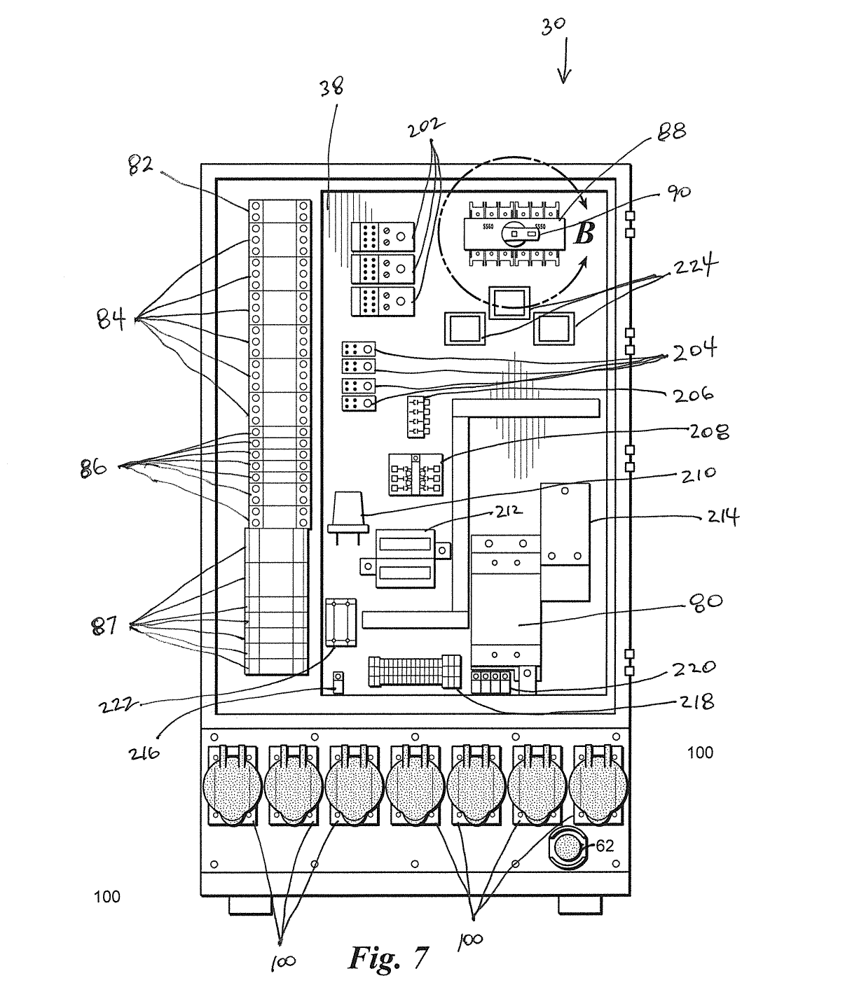

Referring next to FIG. 7, second compartment 38 contains a main 3-phase supply breaker 80 with shunt trip (for over/under frequency tripping) breaker auxiliary transformer circuit breaker 82, 3-phase circuit breakers (50/60 Hz) 84, 50 Hz single phase auxiliary circuit breakers 86, 60 Hz single phase auxiliary circuit breakers 87 and a dial frequency selector switch assembly 88. Second compartment 38 may also include distribution buses, collectively 202 and 204, 24 volt DC fuses 206 and 208, engine control module (ECM) shut down timer 210, and may further include frequency monitor switches 212 for under/over frequency main breaker trip (45/55, 55/65 Hz), air compressor circuit breaker/motor starter 214, ground connection 216, and genset control terminal strip 218. Second compartment 38 may also include buses such as distribution buses 202 and 204, external panel 3-phase bus 220, and auxiliary supply bus 222.

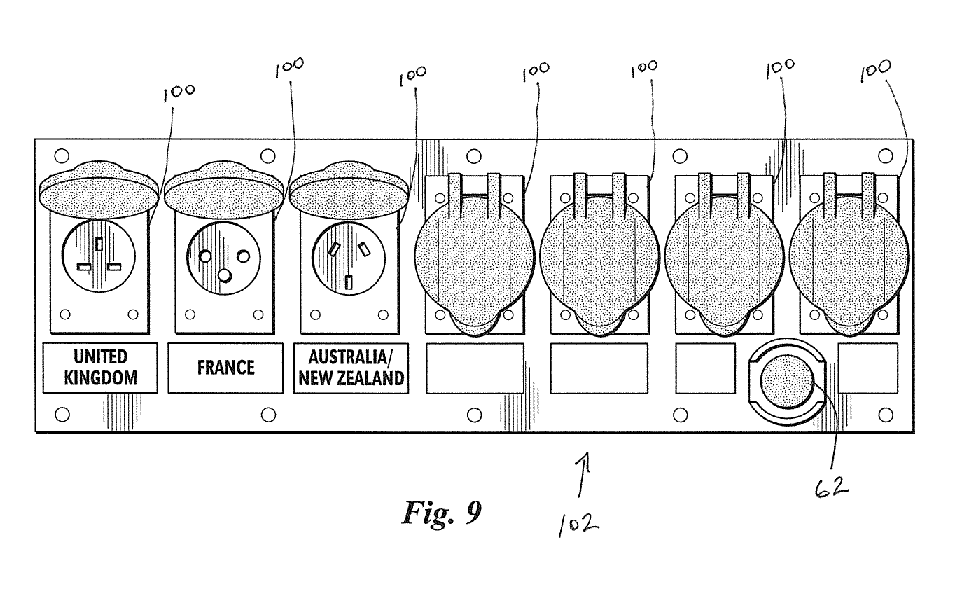

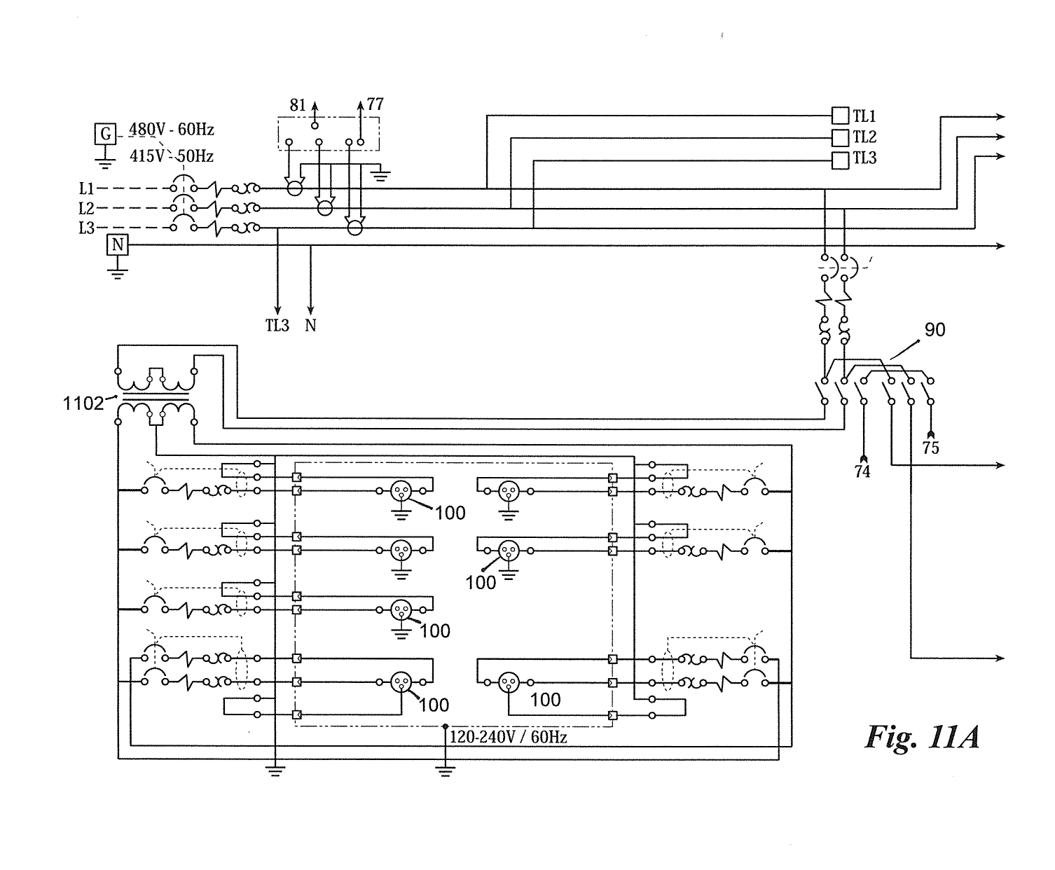

Dual frequency selector switch assembly 88 of FIG. 7 is shown in greater detail in FIG. 8. Dual frequency selector assembly 88 includes switch 90 that may be positioned to select from one of two frequencies, e.g., 60 Hz or 50 Hz. When switch 90 is positioned to select 50 Hz, as shown in FIG. 8, generator 20 provides power at 50 Hz through first receptacle cables 92. When switch 90 is positioned to select 60 Hz, generator 20 provides power at 60 Hz through second receptacle cables 94. As shown in FIG. 10, First receptacle cables 92 are aggregated to communicate with first connector 96 and second receptacle cables 94 are aggregated to communicate with second connector 98.

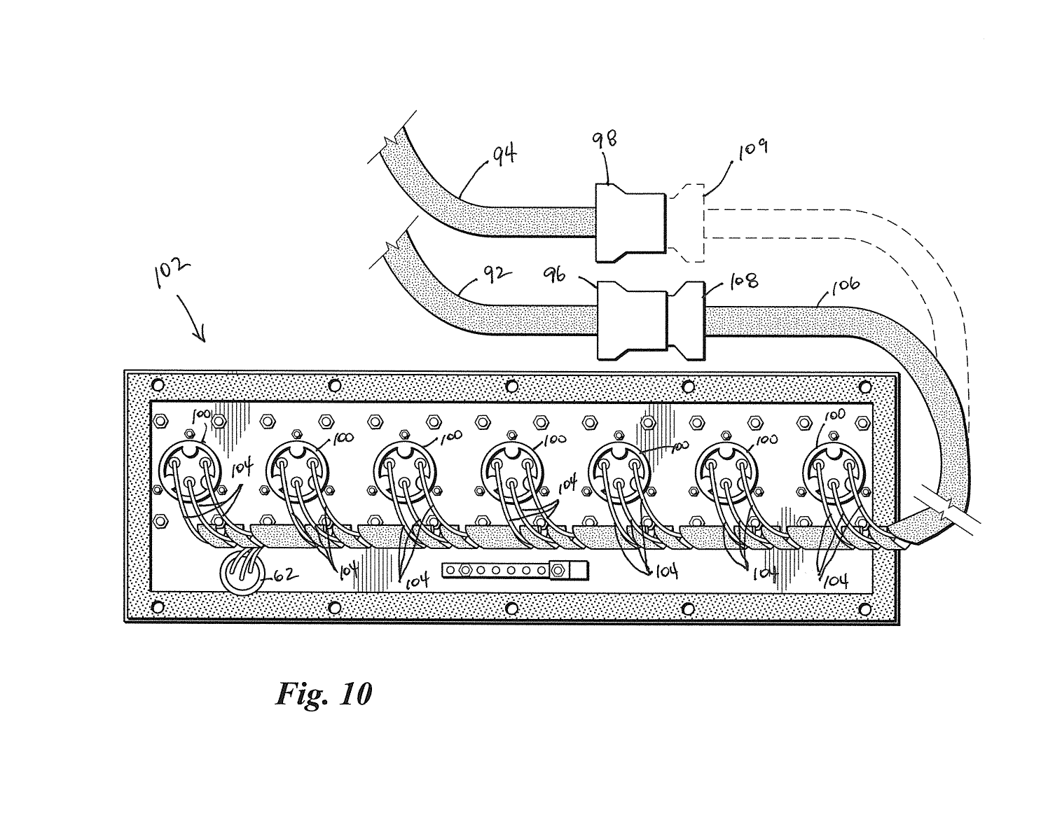

Numerous receptacles 100 are provided to accommodate various power configurations. For example, five 230 volt/50 Hz welding receptacles and five 480 volt welding receptacles may be provided. Optionally, five 230 volt/50 Hz welding receptacles and five 120 volt welding receptacles and two 230 volt 60 Hz receptacles are provided. An example receptacle panel 102 is shown in FIGS. 9 and 10 that includes seven welding receptacles 100 including receptacles suitable for accommodate plugs of a desired type. By way of example and without limitation, FIG. 9 depicts receptacles found in the United Kingdom, France and in Australia/New Zealand but could be any required configuration. Furthermore, FIG. 9 is depicted for the purpose of exemplification. In an actual preferred arrangement all receptacles 100 would be of a single particular configuration compatible with the power supply of the geographic location where the power supply unit is employed for pipeline construction.

A rear view of panel 102 may be seen in FIG. 10. Backs of receptacles 100 receive receptacle cables 104 that are preferably bound into an aggregated receptacle cable 106, which communicates with receptacle connector 108. In the example configuration shown in FIG. 10, receptacle connector 108 is in communication with first connector 96 to receive power from generator 20 at a first frequency, e.g., 50 Hz. However, receptacle connector 108 may alternatively be connected to second connector 98 to receive power at a second frequency, e.g., 60 Hz. In actual operation, panel 102 would be replaced with an alternate panel which would include a connector 109 which would mate connector 98 to receive power at a second frequency. In the preferred arrangement, connectors 96 and 98 would not accommodate the same connectors so that a mistake in connecting to the wrong frequency is minimized.

In an alternate embodiment, connectors 96, 98, 108, and 109 have selectively engaging mating pins and receivers such that when first connector 96 is mated with receptacle connector 108 only the appropriate receptacles 100 receive power, i.e., receptacles 100 that are configured to receive 60 Hz power will be unpowered when receptacle connector 108 is in communication with first connector 96 and receptacles 100 that are in a configuration designed to receive 50 Hz power will be unpowered with receptacle connector 108 is in communication with second connector 94.

Referring back to FIGS. 1, 3 and 4, welding module 10 additionally includes air compressor 120 that is preferably affixed to platform 12. Air compressor module 120 preferably includes compressor 122. An example compressor 122 is four cylinder, pressure lubricated, and rated for 64.1 cfm (1815.1 litre/min) for delivering compressed air at 250 psi (17.2 bar). An electric motor 124 powers compressor 122. Electric motor 124 may be a 20 hp (15 kW) motor that can run on 50 Hz or 60 Hz. Compressor 122 is preferably equipped with dual controls for running in either start/stop or constant run mode.

Air tank 130 is provided on platform 12. Air tank 130 includes air receiver 132 that receives compressed air from compressor 122. Air receiver 132 preferably is a low profile vertical air receiver rated at 115 US gal (435.5 liters) at 250 psi (17.2 bar). Air receiver 132 is preferably provided with a safety relief valve.

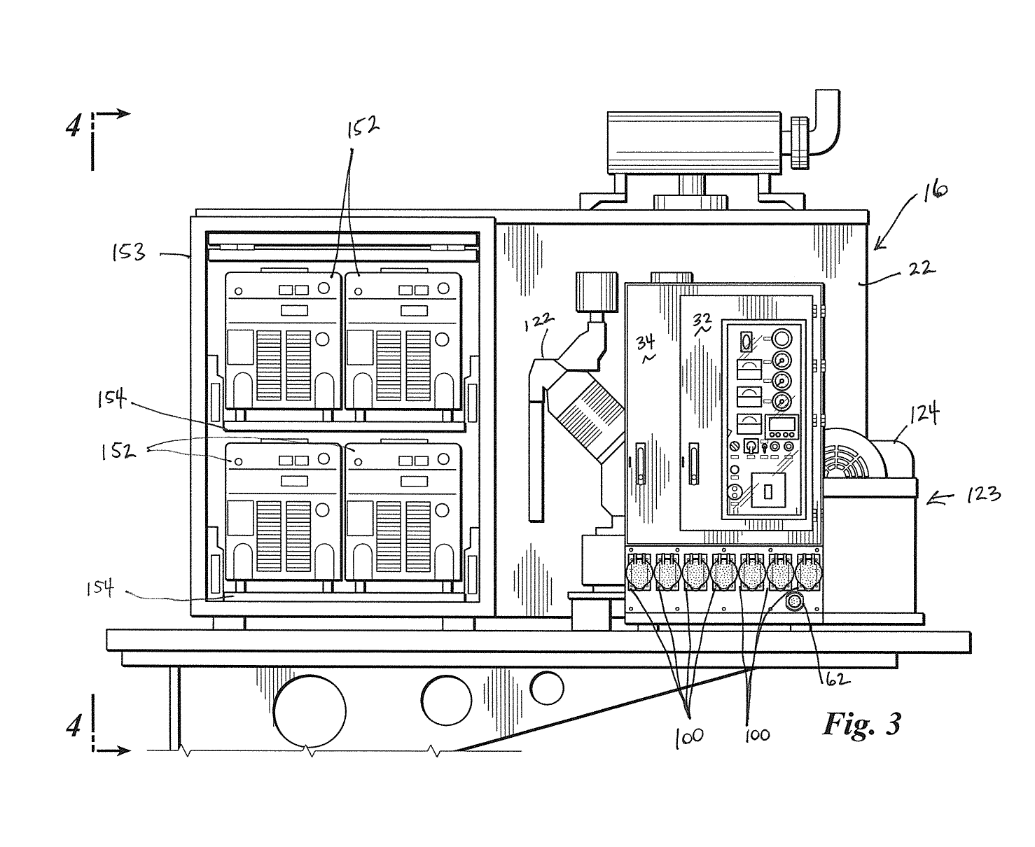

Welding module 150 preferably accommodates multiple welders 152 (FIG. 3). For example, welding module 150 includes lockable box 153 having sliding shelves 154 that support four welders 154. Example welders 154 include Miller XMTY 304, 456 MP or Lincoln Invertec V350-PRO Invertors 50/60 Hz that are vibration mounted on sliding shelves 154.

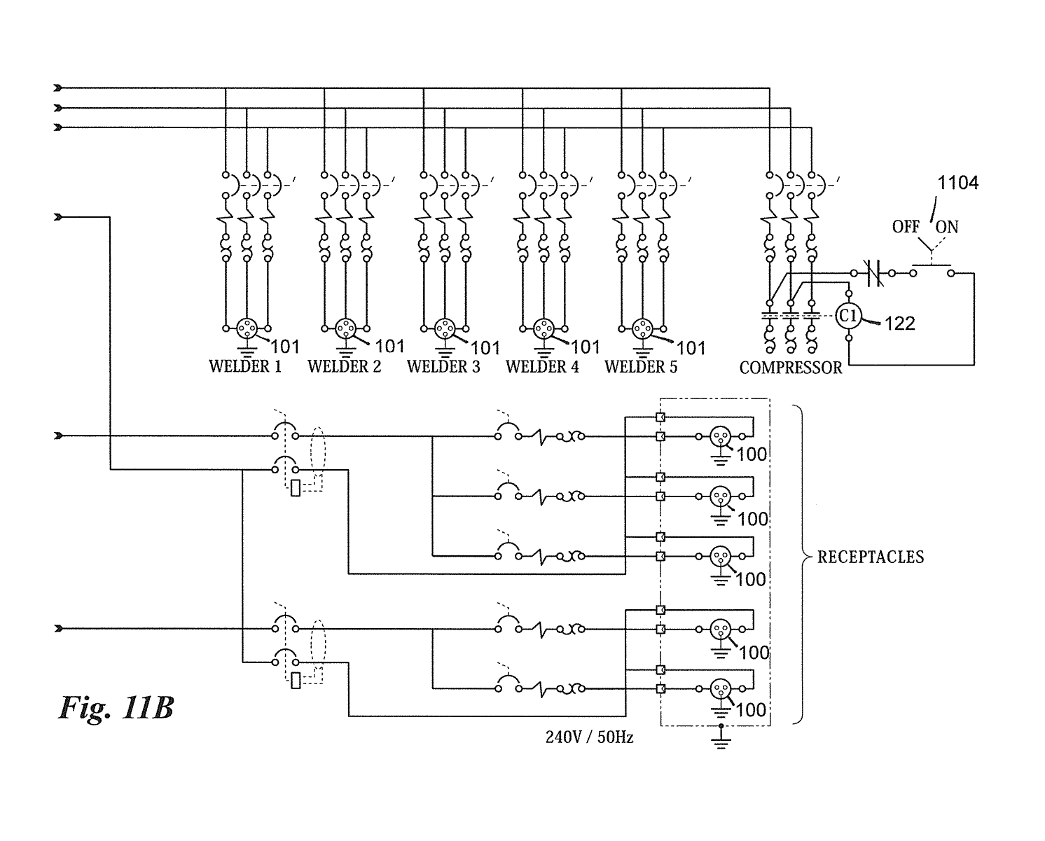

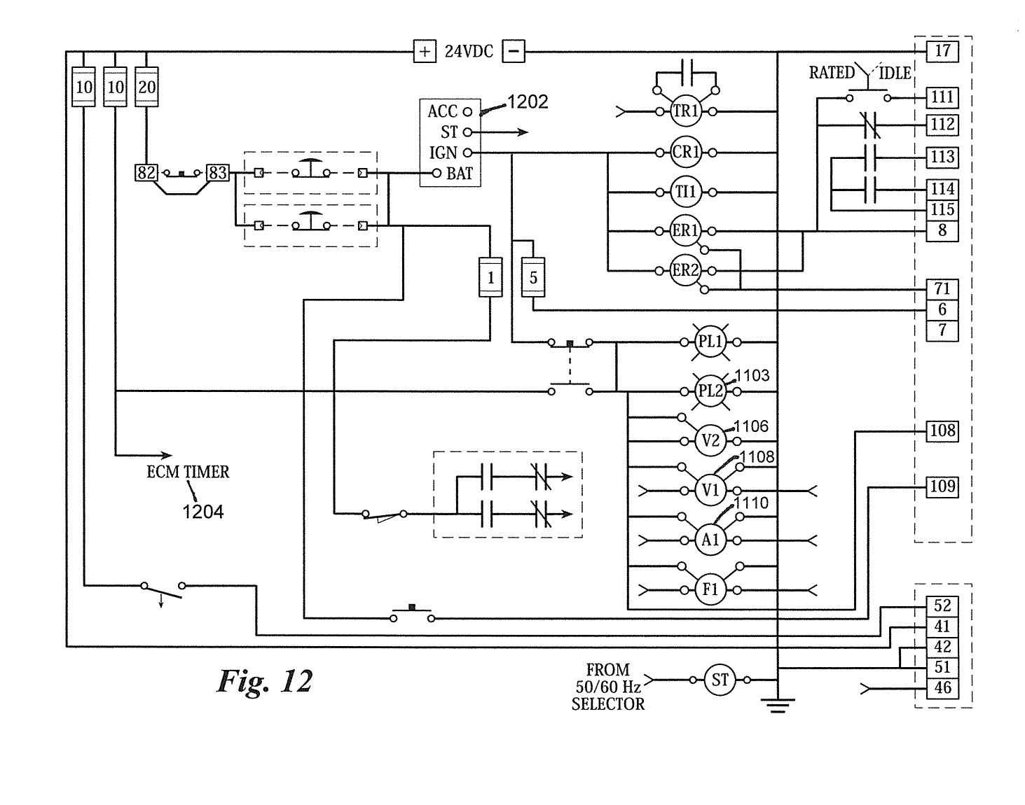

Referring now to FIGS. 11A and 11B, a schematic diagram of a circuit diagram illustrating one possible arrangement of receptacle wiring is shown. The viewpoint of FIG. 11A represents a first portion of receptacle wiring that would be downstream of generator 20. It is understood that FIGS. 11A, 11B, and 12 represent only exemplary embodiments of how the various components of the present disclosure may be electrically connected.

In some embodiments, generator 20 will be an alternating current, three phase generator producing three separate power phases on L1, L2, and L3. The output leads from the generator 20 may be provided with in-line circuit breakers. In some embodiments, the output leads may be protected from magnetic and/or thermal overload as well. In the event of a magnetic, electric, and/or thermal overload, the problematic connection can be severed to protect the generator 20, components downstream of the generator, and any operators nearby.

In the present embodiment, one or more of the generator outputs, L1, L2, and L3 may connect to the set of electrical receptacles 100 in various desired configurations as required by a particular geographic region. The generator may be switched by switch 90 to feed directly to one or more receptacles 100 thereby providing whatever power the generator is generating (it is understood that various circuitry protection devices may interpose the generator and receptacles, such as magnetic, electric, and/or thermal overload protection devices).

In the present embodiment, the generator 20 provides 240V/50 Hz power directly to the outlets 100. 120-240V/60 Hz power may also be provided by the same generator by feeding one or more of the outputs L1, L2, L3 through a transformer 1102 and changing the operating speed of the generator 20. Switch 90 may select whether outputs are transformed or not, as shown. Switch 90 may also change the speed of the generator 20.

In the present embodiment, the single switch 90 may be actuated to adjust all receptacles 100 at once from one power setting to the other. It is understood that in various embodiments, there may be one set of receptacles dedicated to a particular power setting (e.g., 120V/60 Hz) and another set for another setting. In other embodiments, the same receptacles are utilized for multiple settings, and the setting routed to the receptacles is altered by switches, transformers, etc., as needed.

It is also understood that each receptacle 100 may not be connected to all three power leads L1, L2, L3, via transformer or otherwise. In case where only single phase power is needed, each one of the receptacles 100 may attach to only a single direct or transformed power lead. If multi-phase power is required, one or more receptacles 100 can be connected to multiple leads L1, L2, L3, thereby providing one, two or three-phase power.

It can be seen with reference to FIGS. 11A-B that welding receptacles 101 (connected to welders 152) may be continuously powered by the generator 20. In other words, the welding receptacles 101 may not be switched between being transformed or directly connected. In the present embodiment, all the welding receptacles 101 are provided with three-phase power from the generator 20. As with other components, each welding receptacle may be provided with protective devices to guard against electrical, thermal, and/or magnetic overload on any of the power phases.

In the present embodiment, the compressor 122 is also connected to all three power phases from the generator 20. The compressor may have a separate switch 122 for powering on and off. The compressor 122 may be provided with protective devices to guard against electrical, thermal, and/or magnetic overload on any of the power phases.

Referring now to FIG. 12 a schematic diagram of a control panel suitable for use with the systems of the present disclosure is shown. However, it is understood that a control panel may provide more or less functionality than that shown in FIG. 12. In the present embodiment, the control panel runs off of a 24 VDC power supply. This may be a battery that is charged by an alternator (not shown) powered by a diesel engine. In the present embodiment, a multi-position ignition switch 1102 may be provided that will start and stop the engine (and consequently the devices downstream of the generator). The switch 1102 may also provide for limited operation on battery power alone.

The control panel feeds into the various indicators, gauges, and dials described above. Hence, lamps may be illuminated corresponding to various states of operation (e.g., 50 or 60 Hz). The voltage and current produced (1106, 1108, 1110), as well as various system loads may be indicated. Circuit breakers, fuses, and other protective devices may be used as needed to ensure the integrity of the control panel and its ability to safely manage the other devices of the present disclosure.

The present embodiment also provides a timer circuit 1204, that may be used to shut the entire system down after a predetermined amount of time. This may be user selectable and may automatically reset if certain settings are altered on the control panel.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. A device comprising:
an engine mechanically coupled to a generator;
a plurality of electrical receptacles coupled to the generator;
a compressor connected to the generator;
an arc welder receptacle coupled to the generator;
a transformer;
a selector switch for selectively placing the transformer in a circuit containing at least one of the plurality of electrical outlets.

2. The device of claim 1, wherein the generator is a three phase alternating current generator.

3. The device of claim 2, wherein the arc welder receptacle is connected to all three power phases of the generator.

4. The device of claim, 2, where in at least one of the plurality of electrical receptacles is connected to less than three of the power phases of the generator.

5. The device of claim 1, further comprising a vehicle mountable platform retaining the engine and generator.

6. The device of claim 1, wherein the selector switch further controls the engine and generator to change an alternating current frequency of output power from the generator.

7. A mobile power device comprising:
a vehicle mountable platform;
an engine mounted to the platform;
an alternating current generator mechanically powered by the engine;
a plurality of electrical receptacles coupled to the generator;
a transformer selectively integrable to a circuit containing at least one of the plurality of receptacles such that the transformer alters the voltage between the generator and the at least one of the plurality of receptacles; and
a switch that selectively integrates the transformer into the circuit and changes the speed of the engine to change the speed of the generator such that a voltage and cycle of the at least one receptacle is altered.

8. The device of claim 7, wherein the generator is a three phase generator.

9. The device of claim 8, further comprising an arc welder mounted to the platform and connected to the generator.

10. The device of claim 8, further comprising a compressor mounted to the platform and connected to the generator.

11. The device of claim 8, wherein the at least one electrical receptacle is connected to less than three phases of the generator.

12. A method of providing power comprising:
providing a mobile platform;
attaching an engine to the mobile platform;
mechanically connecting an alternating current generator to the engine;
providing a plurality of electrical receptacles coupled to the generator;
selectively incorporating a transformer into a circuit containing at least one of the electrical receptacles to alter a voltage from the generator to the at least one receptacle; and
selectively adjusting an operating speed of the engine to alter a cycle of the generator.

13. The method of claim 12, further comprising connecting a switch to controlling the selective incorporation and the selective adjustment.

14. The method of claim 12, further comprising providing an arc welder on the mobile platform and connecting it to the generator.

15. The method of claim 12, further comprising providing a compressor on the mobile platform and selectively connecting it to the generator.

16. The method of claim 12, wherein the generator is a three phase generator and the at least one of the electrical receptacles is connected to less than three phases of the generator.
